(19) United States
(12) Patent Application Publication
(10) Pub. No.: US 2024/0225107 A1
(43) Pub. Date: Jul. 11, 2024

(54) AEROSOL-GENERATING DEVICE WITH OVERHEATING PREVENTION

(71) Applicant: Philip Morris Products S.A., Neuchatel (CH)

(72) Inventors: Rui Nuno Rodrigues Alves BATISTA, Neuchatel (CH); Alexandra SEREDA, Neuchatel (CH)

(73) Assignee: Philip Morris Products S.A., Neuchatel (CH)

(21) Appl. No.: 18/571,827

(22) PCT Filed: Jun. 22, 2022
(86) PCT No.: PCT/EP2022/066956

§ 371 Date: Dec. 19, 2023

(30) Foreign Application Priority Data
Jun. 29, 2021 (EP) 21182415.6

(51) Int. Cl. A24F 40/44; A24F 40/10; H05B 3/12

(52) U.S. Cl. CPC A24F 40/44; A24F 40/10; H05B 3/12

(57) ABSTRACT

An aerosol-generating device is provided, including: a porous wicking element; and a porous polymeric material layer, the porous polymeric material layer being arranged on a surface of the porous wicking element, and the porous polymeric material layer having a melting point of between 200° C. and 300° C.

The present invention relates to an aerosol-generating device.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided in liquid form. The aerosol-forming substrate may be volatilized in a heating chamber of the aerosol-generating device. A heating assembly comprising a heating element may be arranged in or around the heating chamber for heating the aerosol-forming substrate.

The heating element may be configured as a resistive heating element. The heating element may be arranged adjacent a wicking element configured for wicking the aerosol-forming substrate towards the heating element from a liquid reservoir. If the liquid reservoir is depleted, no more aerosol-forming substrate is wicked towards the heating element. If the heating element is nonetheless operated when no a liquid substrate is present in the wick anymore, overheating may become a problem. Overheating of the wicking material may lead to the release of undesired vapors.

It would be desirable to have a heating assembly for an aerosol-generating device with overheating prevention. It would be desirable to have a heating assembly for an aerosol-generating device in which the release of undesired vapors due to overheating is prevented. It would be desirable to have a heating assembly for an aerosol-generating device with improved safety. It would be desirable to have a heating assembly for an aerosol-generating device with mechanical overheating prevention. It would be desirable to have a heating assembly for an aerosol-generating device with automatic overheating prevention.

According to an embodiment of the invention there is provided an aerosol-generating device. The aerosol-generating device may comprise a porous wicking element. The aerosol-generating device may further comprise a porous polymeric material layer. The porous polymeric material layer may be arranged on a surface of the porous wicking element. The porous polymeric material layer may have a melting point of between 200° C. and 300° C.

According to an embodiment of the invention there is provided an aerosol-generating device. The aerosol-generating device comprises a porous wicking element. The aerosol-generating device further comprises a porous polymeric material layer. The porous polymeric material layer is arranged on a surface of the porous wicking element. The porous polymeric material layer has a melting point of between 200° C. and 300° C.

By providing the aerosol-generating device according to the invention, inhalation of unwanted aerosol components may be prevented.

The aerosol-generating device is preferably a heat not burn device. The operating temperature of the aerosol-generating device may be around 200° C. to 250° C. During operation, the liquid aerosol-forming substrate may be wicked from a liquid storage portion towards the heating element by means of the porous wicking element. The heating element may exemplarily be provided as a heating coil surrounding the porous wicking element. During operation, the heating element may be heated to a temperature of around 200° C. to 250° C. The heating element may be a resistive heating element.

The liquid aerosol-forming substrate may be vaporized next to the heating element at the porous wicking element due to the porous wicking element being saturated with the liquid aerosol-forming substrate. The vaporized aerosol-forming substrate may be entrained in an airflow and subsequently cool down such that an aerosol can be formed. The aerosol may be an inhalable aerosol to be inhaled by a user. The aerosol may flow out of the aerosol-forming device via a mouthpiece.

If the liquid aerosol-forming substrate in the liquid substrate portion is depleted, no liquid aerosol-forming substrate can be wicked by the porous wicking element towards the heating element anymore. As a consequence, the heating element may heat the dry porous wicking element. Heating the dry porous wicking element may be undesired. Heating of the dry porous wicking element may result in an overheating of the porous wicking element. Particularly, unwanted components could be created by heating the dry porous wicking element. The unwanted components may subsequently be entrained in the airflow and inhaled by a user. This inhalation of the unwanted components is undesired.

This potential inhalation of unwanted components is prevented by the present invention. In more detail, the porous polymeric material layer disposed on a surface of the porous wicking element prevents airflow through the porous polymeric material layer after melting of the porous polymeric material layer. The melting point of the porous polymeric material layer is chosen such that the polymeric material melts if the temperature of the porous polymeric material layer becomes too high. This melting point is chosen such that it corresponds to a potential overheating problem of the porous wicking element. In other words, if the porous wicking element runs dry due to a lack of supply of liquid aerosol-forming substrate, the porous polymeric material layer melts and seals the surface of the porous wicking element to prevent airflow through the porous wicking element.

The porous wicking element may be configured as a porous ceramic wicking element.

Airflow through the porous wicking element may be enabled due to the porous nature of the porous ceramic wicking element.

The porous polymeric material layer may be provided as a coating on a surface of the porous wicking element.

Providing the porous polymeric material layer as a coating creates a thin layer on the surface of the porous wicking element so as to not negatively influence the vaporization of the liquid aerosol-forming substrate from the porous wicking element during normal operation.

The porous polymeric material layer may be arranged between the heating element and the porous wicking element.

The porous polymeric material layer may be provided on a proximal surface of the porous wicking element.

As used herein, the terms ‘upstream’ and ‘downstream’, ‘proximal’ and ‘distal’, are used to describe the relative positions of components, or portions of components, of the aerosol-generating device in relation to the direction in which a user draws on the aerosol-generating device during use thereof.

The proximal surface of the porous wicking element may be at a proximal end of the porous wicking element. The proximal end of the porous wicking element may be at a downstream end of the porous wicking element.

If the porous polymeric material layer melts in an impending overheating scenario the melting porous polymeric material layer seals the proximal surface of the porous wicking element to prevent airflow through the proximal surface of the porous wicking element.

The aerosol-generating device may further comprise the mouthpiece. The porous polymeric material layer may be provided on the surface of the porous wicking element facing the mouthpiece.

The surface of the porous wicking element facing the mouthpiece may be the proximal surface of the porous wicking element. The melting of the porous polymeric material layer in an impending overheating scenario may prevent airflow to reach the mouthpiece and thereby prevent inhalation of unwanted components of the aerosol in the overheating scenario.

The porous wicking element may have a porosity between 25% and 75%, preferably between 30% and 60%, more preferably around 55%.

This porosity of the porous wicking element enabled airflow through the porous wicking element.

The porous wicking element may have a pore size of between 40 μm and 80 μm, preferably between 50 μm and 70 μm, more preferably around 60 μm on average.

This pore size of the porous wicking element enabled airflow through the porous wicking element.

The porous polymeric material layer may have a melting point of between 225° C. and 275° C., more preferably around 250° C.

This melting point of the porous polymeric material layer may be chosen to lead to a melting of the porous polymeric material layer in case of an impending overheating scenario of the porous wicking element.

The porous polymeric material layer may have a porosity between 25% and 75%, preferably between 30% and 60%, more preferably around 55%.

This porosity of the porous polymeric material layer enables airflow through the porous polymeric material layer during normal operation. In other words, if an overheating scenario of the porous wicking element is not impending and the porous wicking element is sufficiently provided with liquid aerosol-forming substrate, air can flow through the porous wicking element as well as through the porous polymeric material layer arranged on the surface of the porous wicking element. As a consequence, the aerosol-forming substrate that is vaporized at the porous wicking element can travel through the porous wicking element and through the porous polymeric material layer to subsequently form an inhalable aerosol.

The porous polymeric material layer may have a pore size of between 20 μm and 60 μm, preferably between 30 μm and 50 μm, more preferably around 40 μm on average.

This pore size of the porous polymeric material layer enabled airflow through the porous polymeric material layer.

The porous polymeric material layer may be made of one of meta-phenylene iso-phthalamide, polyacrylonitrile (PAN), polyethylene, polypropylene, polyesters, polyethylene terephthalate, polybutylene terephthalate, polyamide such as aramid, polytrimethylene terephthalate, polyacetal, polycarbonate, polyimide, polyether ketone, polyether ether ketone, polyethersulfone, polyamide-imide, polyphenylene oxide, polyphenylene sulfide, polysulfone, and polyethylene naphthalate and may particularly preferred be made of polyethylene with 30% glass fiber.

Particularly preferred embodiments of the porous polymeric material layer are polytrimethylene terephthalate with a melting point of 264° C., Polyethylene with 30% glass fiber with a melting point of 255° C. and polyacrylonitrile with a melting point of 321° C.

The porous wicking element preferably has a melting point of over 1000° C.

The aerosol-generating device may further comprise an airflow channel. The porous wicking element may be arranged in the airflow channel such that the air flows through the porous wicking element.

The porous wicking element may span the airflow channel. The porous wicking element may be arranged in the airflow channel such that air can only travel through the porous wicking element. In other words, the porous wicking element may be arranged in the airflow channel such that air cannot travel around the porous wicking element. Alternatively, the porous wicking element may be arranged in the airflow channel such that air can travel through the porous wicking element as well as around the porous wicking element. The air traveling around the porous wicking element may mix with the air traveling through the porous wicking element downstream of the porous wicking element. The air traveling through the porous wicking element may carry the vaporized liquid aerosol-forming substrate and mix with the air traveling around the porous wicking element. The mix of air comprising the vaporized liquid aerosol-forming substrate with air not comprising vaporized substrate may lead to the formation of an aerosol downstream of the porous wicking element.

The airflow channel may, upstream of the porous wicking element, be fluidly connected with an air inlet of the aerosol-generating device. The air inlet may be arranged to allow airflow of ambient air into the device. The airflow channel may, downstream of the porous wicking element, be fluidly connected with an air outlet of the aerosol-generating device. The air outlet may be placed in the mouthpiece. The mouthpiece may be the air outlet.

The porous wicking material may have a rectangular shape.

The heating element may be arranged in the airflow channel. The heating element may be arranged at least partly surrounding the porous wicking element. The heating element may be arranged downstream of the porous wicking element.

The porous polymeric material layer may be configured to melt when the temperature of the porous polymeric material layer exceeds 275° C., most preferably when the temperature of the porous polymeric material layer exceeds 250° C.

Because of the melting of the porous polymeric material layer, airflow through the porous polymeric material layer may be prevented after melting. The melting action of the porous polymeric material layer may lead to the porous polymeric material layer no longer being porous. In other words, the melting action of the porous polymeric material layer may close the pores of the porous polymeric material layer such that a polymeric material layer without any porous is the result of the melting action of the porous polymeric material layer.

The porous polymeric material layer may be configured to seal the pores of the surface of the porous wicking element on which the porous polymeric material layer is arranged, when the porous polymeric material layer melts, thereby preventing airflow through this surface of the porous wicking element.

The sealing action of the pores of the surface of the porous wicking element may be achieved by the melting porous polymeric material layer flowing into the pores of the surface of the porous wicking element. Additionally or alternatively, the sealing action of the pores of the surface of the porous wicking element may be achieved by the pores of the porous polymeric material layer being closed during the melting of the porous polymeric material layer.

The porous polymeric material layer may be configured to seal the pores of the whole surface of the porous wicking element, when the porous polymeric material layer melts, thereby preventing airflow through the porous wicking element.

The porous polymeric material layer may be configured to seal the pores of more than one surface of the porous wicking element, when the porous polymeric material layer melts, thereby preventing airflow through the porous wicking element.

The sealing of more than one surface of the porous wicking element or of the whole surface of the porous wicking element may be achieved by the porous polymeric material layer being arranged on more than one surface of the porous wicking element. Preferably, each surface that is covered by the porous polymeric material layer before an overheating scenario is sealed in an overheating scenario due to the melting action of the porous polymeric material layer. If it is desirable to seal the whole surface of the porous wicking element during an overheating scenario, preferably the whole surface of the porous wicking element is covered by the porous polymeric material layer before the overheating scenario. As an alternative, it may be desirable to cover the proximal surface of the porous wicking element as well as the side surfaces of the proximal heating element to prevent lateral airflow into the porous wicking element or out of the porous wicking element during an overheating scenario. Consequently, the porous polymeric material layer may be provided on the proximal surface of the porous wicking element as well as on the side surfaces of the porous wicking element.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be provided in a liquid form. The liquid aerosol-forming substrate may comprise additives and ingredients, such as flavourants. The liquid aerosol-forming substrate may comprise water, solvents, ethanol, plant extracts and natural or artificial flavours. The liquid aerosol-forming substrate may comprise nicotine. The liquid aerosol-forming substrate may have a nicotine concentration of between about 0.5% and about 10%, for example about 2%. The liquid aerosol-forming substrate may be contained in the liquid storage portion of the aerosol-generating article, in which case the aerosol-generating article may be denoted as a cartridge.

The aerosol-generating device may comprise an atomizer. The atomizer is provided to atomize the liquid aerosol-forming substrate to form an aerosol, which can subsequently be inhaled by a user. The atomizer may comprise the heating element, in which case the atomizer may be denoted as a vaporiser. Generally, the atomizer may be configured as any device which is able to atomize the liquid aerosol-forming substrate. The atomizer may particularly comprise the heating element, the porous wicking element and the porous polymeric material layer.

The porous wicking element may have a fibrous or spongy structure. The porous wicking element preferably comprises a bundle of capillaries. For example, the porous wicking element may comprise a plurality of fibres or threads or other fine bore tubes. The fibres or threads may be generally aligned to convey liquid to the heater. Alternatively, the porous wicking element may comprise sponge-like or foam-like material. The structure of the porous wicking element forms a plurality of small bores or tubes, through which the liquid can be transported by capillary action. The porous wicking element may comprise any suitable material or combination of materials. Examples of suitable materials are a sponge or foam material, ceramic- or graphite-based materials in the form of fibres or sintered powders, foamed metal or plastics materials, a fibrous material, for example made of spun or extruded fibres, such as cellulose acetate, polyester, or bonded polyolefin, polyethylene, ethylene or polypropylene fibres, nylon fibres or ceramic. Ceramic is a particularly preferred material for the porous wicking element. The porous wicking element may have any suitable capillarity and porosity so as to be used with different liquid physical properties. The liquid has physical properties, including but not limited to viscosity, surface tension, density, thermal conductivity, boiling point and vapour pressure, which allow the liquid to be transported through the porous wicking element by capillary action. The porous wicking element may be configured to convey the aerosol-forming substrate to the heating element. The porous wicking element may extend into interstices in the heating element.

The liquid storage portion may be any suitable shape and size. For example, the liquid storage portion may be substantially cylindrical. The cross-section of the liquid storage portion may, for example, be substantially circular, elliptical, square or rectangular.

The liquid storage portion may comprise a housing. The housing may comprise a base and one or more sidewalls extending from the base. The base and the one or more sidewalls may be integrally formed. The base and one or more sidewalls may be distinct elements that are attached or secured to each other. The housing may be a rigid housing. As used herein, the term ‘rigid housing’ is used to mean a housing that is self-supporting. The rigid housing of the liquid storage portion may provide mechanical support to the aerosol-generating means. The liquid storage portion may comprise one or more flexible walls. The flexible walls may be configured to adapt to the volume of the liquid aerosol-forming substrate stored in the liquid storage portion. The housing of the liquid storage portion may comprise any suitable material. The liquid storage portion may comprise substantially fluid impermeable material. The housing of the liquid storage portion may comprise a transparent or a translucent portion, such that liquid aerosol-forming substrate stored in the liquid storage portion may be visible to a user through the housing. The liquid storage portion may be configured such that aerosol-forming substrate stored in the liquid storage portion is protected from ambient air. The liquid storage portion may be configured such that aerosol-forming substrate stored in the liquid storage portion is protected from light. This may reduce the risk of degradation of the substrate and may maintain a high level of hygiene.

The liquid storage portion may be substantially sealed. The liquid storage portion may comprise one or more outlets for liquid aerosol-forming substrate stored in the liquid storage portion to flow from the liquid storage portion to the aerosol-generating device. The liquid storage portion may comprise one or more semi-open inlets. This may enable ambient air to enter the liquid storage portion. The one or more semi-open inlets may be semi-permeable membranes or one-way valves, permeable to allow ambient air into the liquid storage portion and impermeable to substantially prevent air and liquid inside the liquid storage portion from leaving the liquid storage portion. The one or more semi-open inlets may enable air to pass into the liquid storage portion under specific conditions. The liquid storage portion may be arranged permanently in the main body of the aerosol-generating device. The liquid storage portion may be refillable. Alternatively, the liquid storage portion may be configured as a replaceable liquid storage portion. The liquid storage portion may be part of or configured as a replaceable cartridge. The aerosol-generating device may be configured for receiving the cartridge. A new cartridge may be attached to the aerosol-generating device when the initial cartridge is spent.

Preferably, the porous wicking element is in fluid communication with the liquid storage portion so as to wick liquid aerosol-forming substrate from the liquid storage portion. The porous wicking element is preferably configured to wick the liquid aerosol-forming substrate from the liquid storage portion to the heating element.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

A wall of the housing of the aerosol-generating device may be provided with at least one air inlet. The air inlet may be a semi-open inlet. The semi-open inlet may be an inlet which permits air or fluid flow in one direction, such as into the device, but at least restricts, preferably prohibits, air or fluid flow in the opposite direction. The semi-open inlet preferably allows ambient air to enter the aerosol-generating device. Air or liquid may be prevented from leaving the aerosol-generating device through the semi-open inlet. The semi-open inlet may for example be a semi-permeable membrane, permeable in one direction only for air, but is air- and liquid-tight in the opposite direction. The semi-open inlet may for example also be a one-way valve. Preferably, the semi-open inlets allow air to pass through the inlet only if specific conditions are met, for example a minimum depression in the aerosol-generating device or a volume of air passing through the valve or membrane.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium- titanium- zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The heating element is preferably configured as a resistive heating coil that is arranged at least partly surrounding the porous wicking element. Alternatively, the heating element may exemplarily be a capillary tube heater, a mesh heater or a metal plate heater. The heating element may comprise a flat heater with for example a solid or mesh surface. The heating element may comprise an arrangement of filaments. The heating element may be arranged in direct contact with the proximal surface of the porous polymeric material layer.

Below, there is provided a non-exhaustive list of non-limiting examples. Any one or more of the features of these examples may be combined with any one or more features of another example, embodiment, or aspect described herein.

Example A: An aerosol-generating device comprising:
a porous wicking element; and
a porous polymeric material layer, wherein the porous polymeric material layer is arranged on a surface of the porous wicking element, wherein the porous polymeric material layer has a melting point of between 200° C. and 300° C.

Example B: The aerosol-generating device according to example A, wherein the porous wicking element is configured as a porous ceramic wicking element.

Example C: The aerosol-generating device according to any of the preceding examples, wherein the porous polymeric material layer is provided as a coating on a surface of the porous wicking element.

Example D: The aerosol-generating device according to any of the preceding examples, wherein the porous polymeric material layer is provided on a proximal surface of the porous wicking element.

Example E: The aerosol-generating device according to any of the preceding examples, wherein the aerosol-generating device further comprises a mouthpiece, and wherein the porous polymeric material layer is provided on the surface of the porous wicking element facing the mouthpiece.

Example F: The aerosol-generating device according to any of the preceding examples, wherein the porous wicking element has a porosity between 25% and 75%, preferably between 30% and 60%, more preferably around 55%.

Example G: The aerosol-generating device according to any of the preceding examples, wherein the porous wicking element has a pore size of between 40 μm and 80 μm, preferably between 50 μm and 70 μm, more preferably around 60 μm on average.

Example H: The aerosol-generating device according to any of the preceding examples, wherein the porous polymeric material layer has a melting point of between 225° C. and 275° C., more preferably around 250° C.

Example I: The aerosol-generating device according to any of the preceding examples, wherein the porous polymeric material layer has a porosity between 25% and 75%, preferably between 30% and 60%, more preferably around 55%.

Example J: The aerosol-generating device according to any of the preceding examples, wherein the porous polymeric material layer has a pore size of between 20 μm and 60 μm, preferably between 30 μm and 50 μm, more preferably around 40 μm on average.

Example K: The aerosol-generating device according to any of the preceding examples, wherein the porous polymeric material layer is made of one of meta-phenylene iso-phthalamide, polyacrylonitrile (PAN), polyethylene, polypropylene, polyesters, polyethylene terephthalate, polybutylene terephthalate, polyamide such as aramid, polytrimethylene terephthalate, polyacetal, polycarbonate, polyimide, polyether ketone, polyether ether ketone, polyethersulfone, polyamide-imide, polyphenylene oxide, polyphenylene sulfide, polysulfone, and polyethylene naphthalate and is particularly preferred made of polyethylene with 30% glass fiber.

Example L: The aerosol-generating device according to any of the preceding examples, wherein the aerosol-generating device further comprises an airflow channel, and wherein the porous wicking element is arranged in the airflow channel such that the air flows through the porous wicking element.

Example M: The aerosol-generating device according to any of the preceding examples, wherein the porous polymeric material layer is configured to melt when the temperature of the porous polymeric material layer exceeds 275° C., most preferably when the temperature of the porous polymeric material layer exceeds 250° C.

Example N: The aerosol-generating device according to any of the preceding examples, wherein the porous polymeric material layer is configured to seal the pores of the surface of the porous wicking element on which the porous polymeric material layer is arranged, when the porous polymeric material layer melts, thereby preventing airflow through this surface of the porous wicking element.

Example O: The aerosol-generating device according to any of the preceding examples, wherein the porous polymeric material layer is configured to seal the pores of the whole surface of the porous wicking element, when the porous polymeric material layer melts, thereby preventing airflow through the porous wicking element.

Features described in relation to one embodiment may equally be applied to other embodiments of the invention.

The invention will be further described, by way of example only, with reference to the accompanying drawings in which:

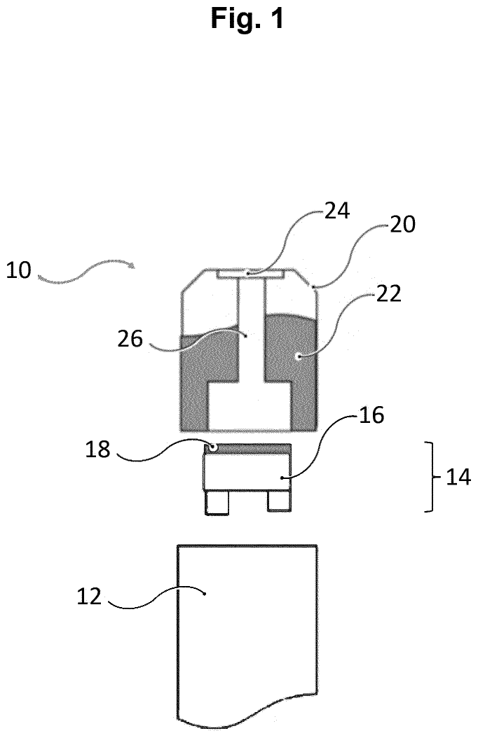

FIG. 1 shows a sectional view of an aerosol-generating device according to the invention in a disassembled state; and

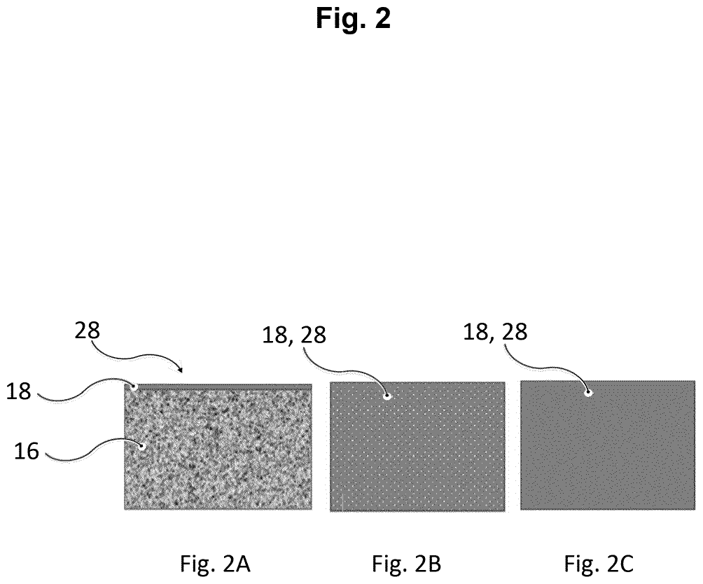

FIGS. 2A to 2C show a more detailed view of a porous wicking element and a porous polymeric material layer of the aerosol-generating device.

FIG. 1 shows an aerosol-generating device 10. The aerosol-generating device 10 comprises a main body 12. The main body 12 comprises a power supply (not shown) and control circuitry (not shown).

FIG. 1 further shows an atomizer 14. The atomizer 14 comprises a porous wicking element 16 and a porous polymeric material layer 18. The atomizer 14 further comprises a heating element (not shown). The porous wicking element 16 and the porous polymeric material layer 18 will be described in more detail with reference to FIG. 2 below.

FIG. 1 further shows a cartridge 20. The cartridge 20 comprises a liquid storage portion 22. In the liquid storage portion 22, liquid aerosol-forming substrate is stored. The liquid aerosol-forming substrate is wicked, by means of the porous wicking element 16, towards the heating element of the atomizer 14. The heating element may be configured as a resistive coil wrapped around the porous wicking element 16 and the porous polymeric material layer 18 or alternatively as a flat heater, such as a mesh heater, adjacent the porous polymeric material layer 18. As a further alternative, the heating element may be provided as a conductive filament embedded in the porous wicking element 16 or printed onto the porous wicking element 16.

The cartridge 20 further comprises a mouthpiece 24. Aerosol generated by the aerosol-generating device 10 may leave the aerosol-generating device 10 via the mouthpiece 24 of the cartridge 20 to be inhaled by a user.

Upstream of the mouthpiece 24, FIG. 1 shows an airflow channel 26. The airflow channel 26 fluidly connects the atomizer 14 with the mouthpiece 24. The atomizer 14 is arranged in the airflow channel 26. Air flows through the atomizer 14 into the airflow channel 26 and further out of the device through the mouthpiece 24.

FIG. 1 shows the aerosol-generating device 10 in a disassembled state. When the aerosol-generating device 10 is assembled, the atomizer 14 is sandwiched between the cartridge 20 and the main body 12. Air flows to the atomizer 14 via an air inlet (not shown) of the aerosol-generating device 10. As shown in FIG. 1, the atomizer 14 is arranged in the airflow channel 26 so that the air drawn towards the atomizer 14 flows through the atomizer 14. After leaving the atomizer 14, the air continues its way through the airflow channel 26 and an inhalable aerosol is formed. The inhalable aerosol finally leaves the device through the mouthpiece 24.

FIG. 2 shows the porous wicking element 16 and the porous polymeric material layer 18. In FIG. 2A, the porous wicking element 16 is shown. A proximal surface 28 of the porous wicking element 16 is covered by the porous polymeric material layer 18. FIG. 2A is a side view. The same configuration as in FIG. 2A can be seen in FIG. 2B. However, FIG. 2B is a top view. As can be seen in FIG. 2B, the proximal surface 28 of the porous wicking element 16 is covered by the porous polymeric material layer 18. As can also be seen in FIG. 2B, the porous polymeric material layer 18 is porous such that air can travel through the porous polymeric material layer 18. Since the porous wicking element 16 is also porous, air can fully travel through the porous wicking element 16 as well as the porous polymeric material layer 18. The porous polymeric material layer 18 is facing the mouthpiece 24 of the aerosol-generating device 10 as shown in FIG. 1.

The porous polymeric material layer 18 has the function of sealing the proximal surface 28 of the porous wicking element 16 in case of an impending overheating problem. When the liquid aerosol-forming substrate in the liquid storage portion 22 is depleted, the porous wicking element 16 can no longer wick liquid aerosol-forming substrate. The heating element can then no longer vaporize the liquid aerosol-forming substrate in the porous wicking element 16, since the porous wicking element 16 runs dry. In this case, the temperature of the porous wicking element 16 may rise and unwanted components may be released. These unwanted components may then be drawn through the porous wicking element 16 together with the air that is drawn through the porous wicking element 16. To prevent this process, the porous polymeric material layer 18 has a melting point of around 250° C. This melting point leads to a melting of the porous polymeric material layer 18, when the porous wicking element 16 runs dry of aerosol-forming substrate but the heating element keeps heating the porous wicking element 16. As a consequence, as shown in FIG. 2C, the porous polymeric material layer 18 melts and closes the pores of the porous wicking element 16. This leads to air no longer being able to be drawn through the porous wicking element 16, as the proximal surface 28 of the porous wicking element 16 is sealed.

Alternatively to the porous polymeric material layer 18 only being arranged on the proximal surface 28 of the porous wicking element 16, any of the surfaces of the porous wicking element 16 may be coated with the porous polymeric material layer 18, if desired.

1.-15. (canceled)

16. An aerosol-generating device, comprising:
a porous wicking element; and
a porous polymeric material layer,
wherein the porous polymeric material layer is arranged on a surface of the porous wicking element, and
wherein the porous polymeric material layer has a melting point of between 200° C. and 300° C.

17. The aerosol-generating device according to claim 16, wherein the porous wicking element is configured as a porous ceramic wicking element.

18. The aerosol-generating device according to claim 16, wherein the porous polymeric material layer is provided as a coating on a surface of the porous wicking element.

19. The aerosol-generating device according to claim 16, wherein the porous polymeric material layer is provided on a proximal surface of the porous wicking element.

20. The aerosol-generating device according to claim 16,
further comprising a mouthpiece,
wherein the porous polymeric material layer is provided on the surface of the porous wicking element facing the mouthpiece.

21. The aerosol-generating device according to claim 16, wherein the porous wicking element has a porosity between 25% and 75%.

22. The aerosol-generating device according to claim 16, wherein the porous wicking element has a pore size of between 40 μm and 80 μm on average.

23. The aerosol-generating device according to claim 16, wherein the porous polymeric material layer has a melting point of between 225° C. and 275° C.

24. The aerosol-generating device according to claim 16, wherein the porous polymeric material layer has a porosity between 25% and 75%.

25. The aerosol-generating device according to claim 16, wherein the porous polymeric material layer has a pore size of between 20 μm and 60 μm on average.

26. The aerosol-generating device according to claim 16, wherein the porous polymeric material layer is made of one of meta-phenylene iso-phthalamide, polyacrylonitrile (PAN), polyethylene, polypropylene, polyesters, polyethylene terephthalate, polybutylene terephthalate, polyamide such as aramid, polytrimethylene terephthalate, polyacetal, polycarbonate, polyimide, polyether ketone, polyether ether ketone, polyethersulfone, polyamide-imide, polyphenylene oxide, polyphenylene sulfide, polysulfone, and polyethylene naphthalate.

27. The aerosol-generating device according to claim 16,
further comprising an airflow channel,
wherein the porous wicking element is arranged in the airflow channel such that air flows through the porous wicking element.

28. The aerosol-generating device according to claim 16, wherein the porous polymeric material layer is configured to melt when a temperature of the porous polymeric material layer exceeds 275° C.

29. The aerosol-generating device according to claim 16, wherein the porous polymeric material layer is configured to seal pores of the surface of the porous wicking element on which the porous polymeric material layer is arranged, when the porous polymeric material layer melts, thereby preventing airflow through the surface of the porous wicking element.

30. The aerosol-generating device according to claim 16, wherein the porous polymeric material layer is configured to seal pores of a whole surface of the porous wicking element, when the porous polymeric material layer melts, thereby preventing airflow through the porous wicking element.
